(19) United States
(12) Patent Application Publication
(10) Pub. No.: US 2025/0122400 A1
(43) Pub. Date: Apr. 17, 2025

(54) DISPERANT, COMPOSITION, AND PRESSURE-SENSITIVE FILM

(71) Applicants: Avary Holding (Shenzhen) Co., Limited., Shenzhen (CN); QING DING PRECISION ELECTRONICS (HUAIAN) CO.,LTD, Huai an (CN); GARUDA TECHNOLOGY CO., LTD., New Taipei (TW)

(72) Inventors: HSIAO-TING HSU, New Taipei (TW); MING-JAAN HO, New Taipei (TW); KUAN-YING CHEN, New Taipei (TW)

(21) Appl. No.: 18/379,441

(22) Filed: Oct. 12, 2023

(51) Int. Cl. C09D 133/14; C08F 220/28; C08K 3/04; C09D 7/61

(52) U.S. Cl. CPC C09D 133/14; C08F 220/282; C09D 7/61; C08K 3/04

(57) ABSTRACT

A dispersant is applied in pressure-sensitive materials and has a chemical structural formula of

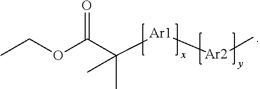

Ar1 represents a group selected from a group consisting of

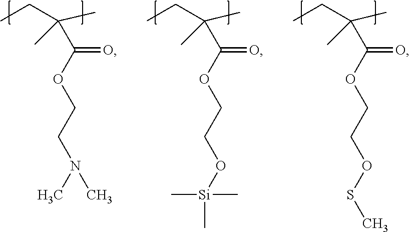

and any combination thereof. Ar2 represents a group selected from a group consisting of

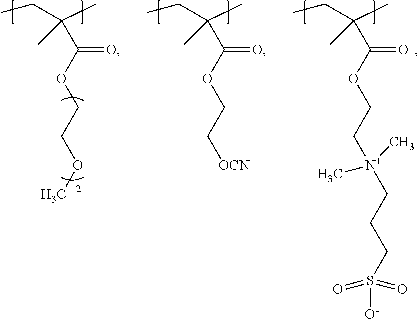

and any combination thereof. A degree of polymerization x and a degree of polymerization y are respectively greater than zero. A composition having the dispersant and a pressure-sensitive film formed by the composition are also provided.

### FIELD

The subject matter herein generally relates to a dispersant applied to pressure-sensitive materials, a composition having the dispersant, and a pressure-sensitive film formed by the composition.

### BACKGROUND

Pressure sensing structures are usually used in electronic products to sense pressure values. Therefore, in order to improve the use experience of the electronic products, requirements for the sensitivity of pressure sensing structures becomes higher and higher.

Therefore, there is room for improvement within the art.

### BRIEF DESCRIPTION OF THE DRAWINGS

Implementations of the present disclosure will now be described, by way of embodiments, with reference to the attached figures.

FIG. 1 is a schematic diagram illustrating a pressure sensing structure according to an embodiment of the present disclosure.

FIG. 2 is an electron microscope diagram illustrating a pressure-sensitive film of according to Example 1 of the present disclosure.

FIG. 3 is an electron microscope diagram illustrating a pressure-sensitive film of according to Example 2 of the present disclosure.

FIG. 4 is an electron microscope diagram illustrating a pressure-sensitive film of according to Example 3 of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts may be exaggerated to better illustrate details and features of the present disclosure.

The disclosure is illustrated by way of example and not by way of limitation in the figures of the accompanying drawings, in which like references indicate similar elements. It should be noted that references to “an” or “one” embodiment in this disclosure are not necessarily to the same embodiment, and such references mean “at least one.”

The term “comprising,” when utilized, means “including, but not necessarily limited to”; it specifically indicates open-ended inclusion or membership in the so-described combination, group, series, and the like.

An embodiment of a dispersant applied in pressure-sensitive materials is provided. The dispersant has a chemical structural formula of

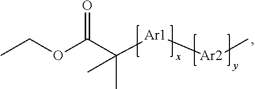

wherein Ar1 represents a group selected from a group consisting of

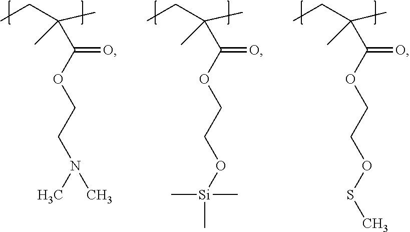

and any combination thereof, Ar2 represents a group selected from a group consisting of

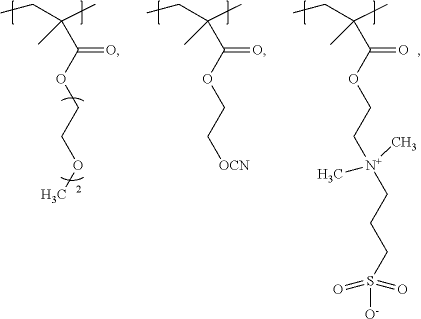

and any combination thereof. A degree of polymerization x and a degree of polymerization y are respectively greater than zero. In at least one embodiment, in the dispersant, a molecular weight of a group of

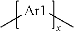

may be in a range of 7000 to 11000, and a ratio of the molecular weight of the group of

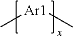

to a molecular weight of a group of

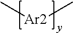

may be in a range of 1:3 to 1:7.

An embodiment of a composition is provided. The composition includes the above dispersant, carbon black particles, a polymer resin, and a solvent.

In at least one embodiment, in the composition, a weight percentage of the dispersant may be in a range of 5% to 10%, a weight percentage of the carbon black particles may be in a range of 5% to 10%, a weight percentage of the polymer resin may be in a range of 20% to 50%, a weight percentage of the solvent may be in a range of 40% to 48%. In at least one embodiment, the composition may have a viscosity of about 4000 cps to 20000 cps.

In the above composition, the dispersant has a narrow molecular weight distribution, which is conducive to obtaining a stabilizing force of an ionic bonding anchoring group with a stable length, thereby facilitating a stable formation of a 3D structural network between the anchoring groups and the carbon black particles. The 3D structural network includes multiple network-like micro and stable conductive bridges formed by the anchoring groups and the carbon black particles, thereby helping to avoid inconsistent spacing between the carbon black particles and local agglomeration of the carbon black particles, so that the dispersion effect of the composition can be enhanced, and it is also helpful to reduce the amount of the carbon black particles added, and there is no need to use a large amount of the carbon black particles to ensure electrical connections.

In at least one embodiment, a ratio of the weight percentage of the polymer resin to the weight percentage of the carbon black particles may be in a range of 5:2 to 9:2.

The carbon black particles are conductive particles and may be selected from a group consisting of acetylene black, Super-P, Ketjen black, and any combination thereof.

The polymer resin may be selected from a group consisting of epoxy resin, acrylic resin, and any combination thereof. In at least one embodiment, a molecular weight of the polymer resin may be in a range of 30000 to 100000.

The solvent may be selected from a group consisting of aromatic hydrocarbons, aliphatic hydrocarbons, alcohol ethers, esters, ketones, alcohols, vegetable oils, mineral oils, and any combination thereof. For example, the solvent may be selected from a group consisting of 2(2-Ethoxyethoxy)ethanol, 2-(2-Ethoxyethoxy)ethyl acetate, terpineol, 2-Ethoxyethyl acetate, 2-Butoxyethyl acetate, butyldiglycol, 2-(2-Butoxyethoxy)ethyl acetate, isophorone, and any combination thereof. In at least one embodiment, the solvent may be selected from a group consisting of 2(2-Ethoxyethoxy)ethanol, 2-(2-Ethoxyethoxy)ethyl acetate, and any combination thereof, which is beneficial to the mixing and dispersion of each component of the composition.

In at least one embodiment, the composition may further include an additive. The additive may be selected from a group consisting of a defoaming agent, a leveling agent, a plasticizer, a thickener, a thixotropic agent, and any combination thereof, and may also be other dispersants, such as a silane coupling agent.

An embodiment of a pressure-sensitive film is provided. The pressure-sensitive film is formed by coating and curing the above composition. The pressure-sensitive film may be used as a pressure-sensitive material.

In at least one embodiment, the composition may be printed or sprayed and then cured to form the pressure-sensitive film.

In at least one embodiment, the pressure-sensitive film may have a thickness of 7 microns to 20 microns.

Since the dispersant has the narrow molecular weight distribution, which is conducive to obtaining the stabilizing force of the ionic bonding anchoring group with the stable length, thereby facilitating the stable formation of a 3D structural network between the anchoring groups and the carbon black particles. The 3D structural network includes multiple network-like micro and stable conductive bridges formed by the anchoring groups and the carbon black particles, which is conductive to optimizing the spacing between the carbon black particles and avoiding the local agglomeration of the carbon black particles to enhance the dispersion effect of the composition, and is conductive to the pressure-sensitive film sensing pressure changes when the pressure-sensitive film is subjected to a slight pressure, thereby improving the sensitivity and the reliability of the pressure-sensitive film. At the same time, the multiple network-like micro and stable conductive bridges can also help to reduce the amount of the carbon black particles added, and there is no need to use a large amount of the carbon black particles to ensure electrical connections. Compared with the method of directly sensing pressure changes through carbon-carbon multi-dimensional direct contact, the sensitivity of the pressure-sensitive film is improved. In addition, a reduction in the amount of the carbon black particles added is also beneficial to the smoothness of an appearance of the pressure-sensitive film.

When the ratio of the molecular weight of the group of

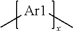

to the molecular weight of the group of

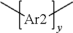

is in a range of 1:3 to 1:7, it is beneficial to optimize the spacing between the carbon black particles and better cooperate with the polymer resin to improve the adhesiveness and film-forming properties of the composition at the same time, which is conducive to ensuring the film-forming effect (e.g. film continuity) of the pressure-sensitive film while ensuring the sensitivity of the pressure-sensitive film.

When the composition has a viscosity of about 4000 cps to 20000 cps, combined with the reduction in the amount of the carbon black particles added, it is beneficial to reduce a required leveling time when forming the pressure-sensitive film, which is beneficial to saving man-hours, and is also beneficial to prevent the pressure-sensitive film from being contaminated by air-suspended particles in a wet film state.

When the ratio of the weight percentage of the polymer resin to the weight percentage of the carbon black particles is in a range of 5:2 to 9:2, it is beneficial to avoid cracks in the pressure-sensitive film when it is slightly bent (i.e. a bending angle of the pressure-sensitive film is less than 60°), and it is also beneficial to fully cover the carbon black particles and prevent the carbon black particles from being removed from the pressure-sensitive film while ensuring the stability and reliability of the electrical connection of the pressure-sensitive film when the pressure-sensitive film is pressed, thereby avoiding contaminating the product and avoiding affecting the smoothness of the surface of the pressure-sensitive film.

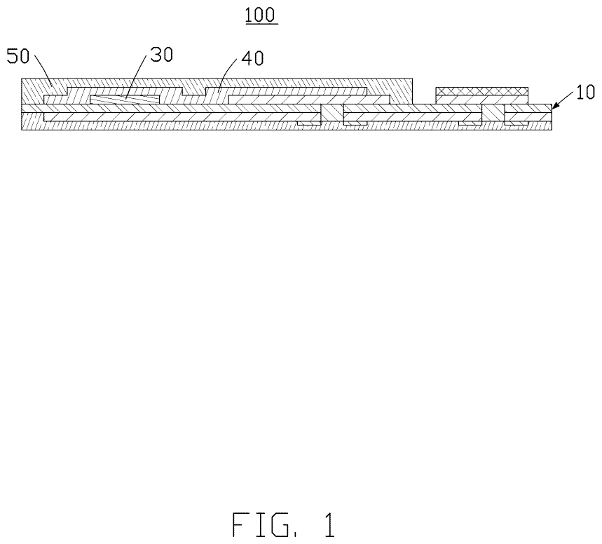

FIG. 1 illustrates an embodiment of a pressure sensing structure 100. The pressure sensing structure 100 includes a circuit board 10 and the above pressure-sensitive film 30 on the circuit board 10. The pressure-sensitive film 30 is electrically connected to the circuit board 10.

In at least one embodiment, the pressure-sensitive film 30 may be electrically connected to the circuit board 10 through silver wires 40.

In at least one embodiment, the pressure sensing structure 100 may further include a packaging layer 50 covering the pressure-sensitive film 30 and the silver wires 40. The packaging layer 50 may include a resin material.

In the above pressure sensing structure 100, the multiple network-like micro and stable conductive bridges in the pressure-sensitive film 30 are also conducive to optimizing the consistency of the resistance values of adjacent bridges to optimize the differential voltage performance and the dispersion of the sensitivity of the pressure sensing structure 100, thereby reducing the noise of the pressure sensing structure 100 and improving the reliability of the pressure sensing structure 100.

### Example 1

A composition was formed by mixing the following components in percentages by weight: 6% of a dispersant, 7.5% of Orion Printex L, 40% of phenoxy modified epoxy resin (Manufacturer: Huntsman Advanced Materials), 1.5% of BYK-300, 3.5% of BYK-024, and 41.5% of 2(2-Ethoxyethoxy)ethanol. The dispersant had a chemical structural formula of

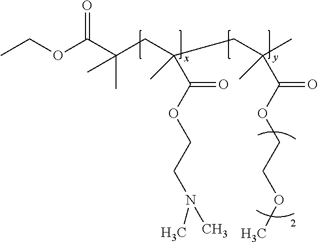

In the dispersant, a molecular weight of a group of

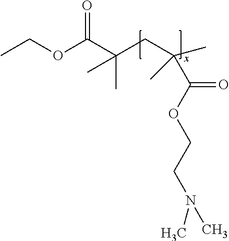

was 9000, a ratio of a molecular weight of a group of

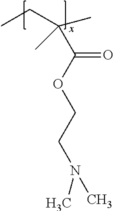

to a molecular weight of a group of

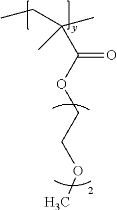

was 1:3.

### Example 2

Different from the above EMBODIMENT 1, the ratio of a molecular weight of the group of

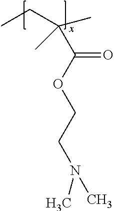

to the molecular weight of the group of

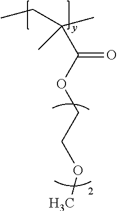

was 1:5.

### Example 3

Different from the above EMBODIMENT 1, the ratio of a molecular weight of the group of

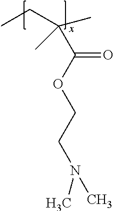

to the molecular weight of the group of

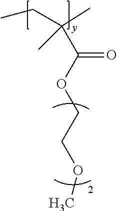

was 1:7.

The composition of each of the above examples was printed to form a pressure-sensitive film with a thickness of 10 microns±2 microns and an initial length of 100 mm as a test sample. An initial resistance of the pressure-sensitive film was measured with a 4-wire ohmmeter. Then the pressure-sensitive film was clamped by a stretching machine and stretched to a length of 100.5 mm (that is a stretched length), and a stretched resistance of the stretched pressure-sensitive film was measured with the 4-wire ohmmeter. The gage factor was calculated by the following formula: GF=((stretched resistance−initial resistance)/initial resistance)/((stretched length−initial length)/stretched length). The gage factors of Examples 1-3 were recorded in the following Table 1.

Measure two resistance values R1 and R2 at any two places on the pressure-sensitive film of each of Examples 1-3, the bridge offset (BOS) was calculated by the following formula: BOS=(R1/(R1+R2)−0.5)*1000, and the BOS of each of Examples 1-3 was recorded in the following Table 1. The BOS was continuously acquired 100 times, and a standard deviation was further calculated as the noise mean, and the noise mean is recorded in Table 1.

TABLE 1

| | Property | | |
|---|---|---|---|
| Product | GF | BOS mV/V | Noise mean uV/V |
| Example 1 | 7.2 | 6.1 | 1.1 |
| Example 2 | 7.8 | 6.3 | 1.1 |
| Example 3 | 8.2 | 6.2 | 1.1 |

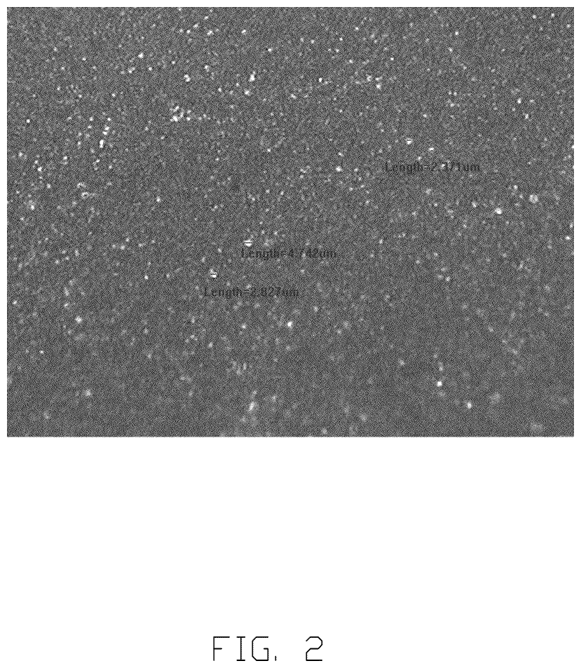

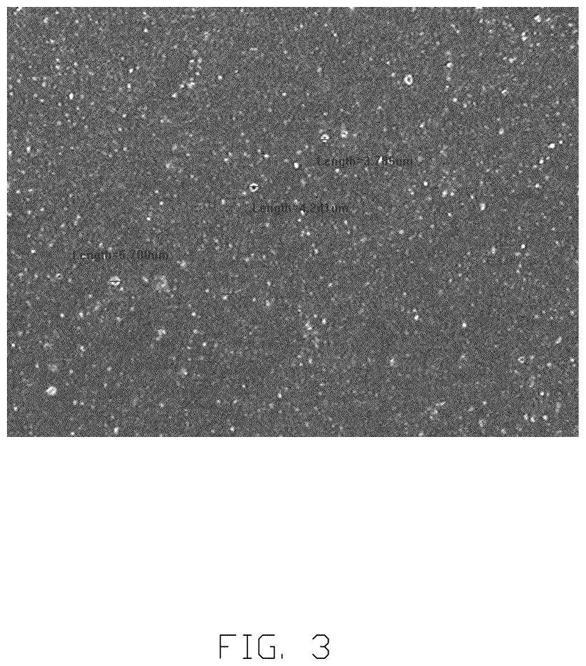

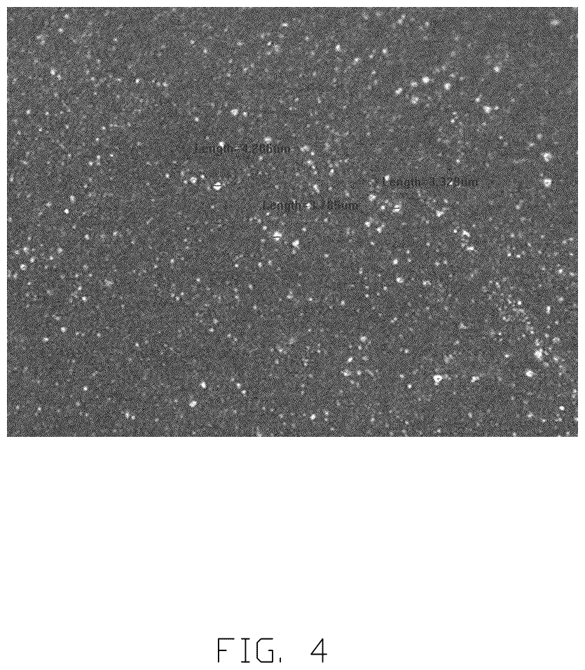

The surface of the pressure-sensitive film formed in each of Examples 1-3 was observed through a microscope, where FIGS. 2 to 4 are electron microscope images of the pressure-sensitive films corresponding to Examples 1 to 3 respectively. It can be seen from the figures that the degree of particle aggregation in the pressure-sensitive film of the present disclosure is very small.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. A dispersant applied in pressure-sensitive materials and having a chemical structural formula of 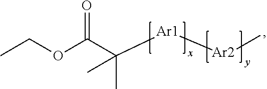
wherein Ar1 represents a group selected from a group consisting of 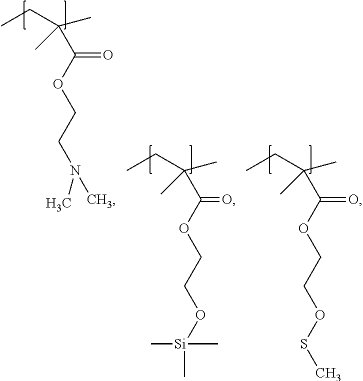
and any combination thereof, Ar2 represents a group selected from a group consisting of 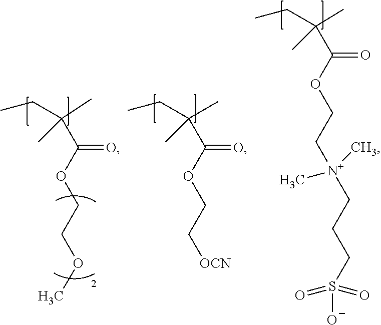
and any combination thereof, a degree of polymerization x and a degree of polymerization y are respectively greater than zero.

2. The dispersant of claim 1, wherein a molecular weight of a group of 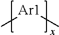
is in a range of 7000 to 11000.

3. The dispersant of claim 1, wherein a ratio of the molecular weight of a group of 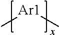
to a molecular weight of a group of 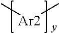
is in a range of 1:3 to 1:7.

4. A composition comprising:
a dispersant;
carbon black particles;
a polymer resin; and
a solvent;
wherein the dispersant has a chemical structural formula of 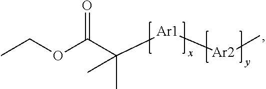
Ar1 represents a group selected from a group consisting of 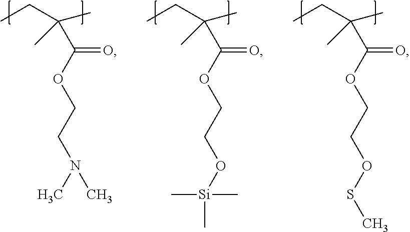
and any combination thereof, Ar2 represents a group selected from a group consisting of 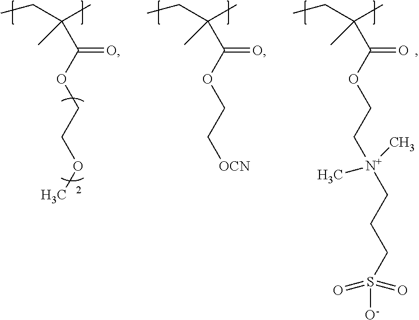
and any combination thereof, a degree of polymerization x and a degree of polymerization y are respectively greater than zero.

5. The composition of claim 4, wherein a molecular weight of a group of 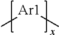
is in a range of 7000 to 11000.

6. The composition of claim 4, wherein a ratio of the molecular weight of a group of 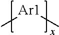
to a molecular weight of a group of 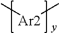
is in a range of 1:3 to 1:7.

7. The composition of claim 4, wherein the dispersant has a weight percentage of 5% to 10% of a total weight of the composition, the carbon black particles have a weight percentage of 5% to 10% of the total weight of the composition, the polymer resin has a weight percentage of 20% to 50% of the total weight of the composition, the solvent has a weight percentage of 40% to 48% of the total weight of the composition.

8. The composition of claim 7, wherein a ratio of the weight percentage of the polymer resin to the weight percentage of the carbon black particles is in a range of 5:2 to 9:2.

9. The composition of claim 7, wherein the composition has a viscosity of about 4000 cps to 20000 cps.

10. The composition of claim 4, wherein the polymer resin is selected from a group consisting of epoxy resin, acrylic resin, and any combination thereof.

11. The composition of claim 10, wherein a molecular weight of the polymer resin is in a range of 30000 to 100000.

12. The composition of claim 4, wherein the solvent is selected from a group consisting of aromatic hydrocarbons, aliphatic hydrocarbons, alcohol ethers, esters, ketones, alcohols, vegetable oils, mineral oils, and any combination thereof.

13. The composition of claim 12, wherein the solvent is selected from a group consisting of 2(2-Ethoxyethoxy)ethanol, 2-(2-Ethoxyethoxy)ethyl acetate, terpineol, 2-Ethoxyethyl acetate, 2-Butoxyethyl acetate, butyldiglycol, 2-(2-Butoxyethoxy)ethyl acetate, isophorone, and any combination thereof.

14. A pressure-sensitive film formed by coating and curing a composition, and the composition comprising:
a dispersant;
carbon black particles;
a polymer resin; and
a solvent;
wherein the dispersant has a chemical structural formula of 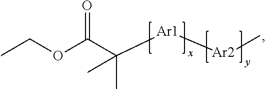
Ar1 represents a group selected from a group consisting of 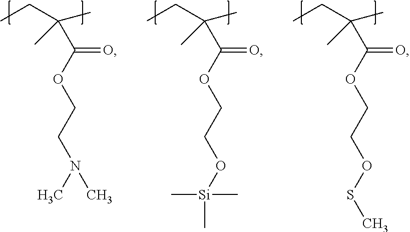
and any combination thereof, Ar2 represents a group selected from a group consisting of 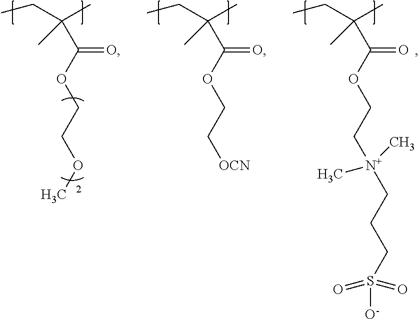
and any combination thereof, a degree of polymerization x and a degree of polymerization y are respectively greater than zero.

15. The pressure-sensitive film of claim 14, wherein a molecular weight of a group of 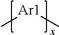
is in a range of 7000 to 11000.

16. The pressure-sensitive film of claim 14, wherein a ratio of the molecular weight of a group of 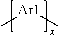
to a molecular weight of a group of 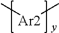
is in a range of 1:3 to 1:7.

17. The pressure-sensitive film of claim 14, wherein the dispersant has a weight percentage of 5% to 10% of a total weight of the composition, the carbon black particles have a weight percentage of 5% to 10% of the total weight of the composition, the polymer resin has a weight percentage of 20% to 50% of the total weight of the composition, the solvent has a weight percentage of 40% to 48% of the total weight of the composition.

18. The pressure-sensitive film of claim 17, wherein a ratio of the weight percentage of the polymer resin to the weight percentage of the carbon black particles is in a range of 5:2 to 9:2.

19. The pressure-sensitive film of claim 17, wherein the composition has a viscosity of about 4000 cps to 20000 cps.

20. The pressure-sensitive film of claim 14, wherein the polymer resin is selected from a group consisting of epoxy resin, acrylic resin, and any combination thereof, and a molecular weight of the polymer resin is in a range of 30000 to 100000.
